(19) United States
(12) Patent Application Publication
(10) Pub. No.: US 2018/0021888 A1
(43) Pub. Date: Jan. 25, 2018

(54) LASER WELDING SYSTEMS FOR ALUMINUM ALLOYS AND METHODS OF LASER WELDING ALUMINUM ALLOYS

(71) Applicant: Illinois Tool Works Inc., Glenview, IL (US)

(72) Inventors: Shuang Liu, Appleton, WI (US); Erik Miller, Verona, WI (US); Brian Doyle, Glenview, IL (US)

(21) Appl. No.: 15/655,569

(22) Filed: Jul. 20, 2017

Related U.S. Application Data
(60) Provisional application No. 62/365,551, filed on Jul. 22, 2016.

(51) Int. Cl. B23K 26/22; B23K 26/06; B23K 26/082; B23K 26/035; B23K 26/046

(52) U.S. Cl. CPC B23K 26/22; B23K 26/035; B23K 26/046; B23K 26/082; B23K 26/0626

(57) ABSTRACT

Systems and methods of a laser welding device to weld aluminum are disclosed. The device includes a laser generator to generate welding-type lasing power and a lens to focus the welding-type lasing power at a focal point on an aluminum workpiece to generate a weld puddle. A laser scanner to control the lens to move the focal point of the welding-type lasing power in multiple dimensions over the aluminum workpiece during welding, the laser generator and the laser scanner to perform the welding without filler metal being added to the workpiece.

### CROSS-REFERENCE TO RELATED APPLICATIONS

This patent application claims priority to and the benefit of U.S. Provisional Patent Application Ser. No. 62/365,551, filed on Jul. 22, 2016, which is incorporated herein by reference in its entirety.

### BACKGROUND

Welding is a process that has historically been a cost effective joining method. Welding is, at its core, simply a way of bonding two pieces of parent material. Laser welding is a welding technique used to join multiple pieces of metal through the use of a laser. The beam provides a concentrated heat source, enabling a precise control of the heat input and high welding speed, creating a weld with low heat input, and a small heat affected zone. In various applications, filler metal may be needed for different purposes such as filling up the gap, reinforcing the joint, overlaying the substrate surface, building up an object, or acting as a buffering medium. The filler material can be brought into the molten pool, either by pre-deposited layer, or by feeding powder or wire.

Conventional laser-based welding processes use a fixed beam with filler metal. Fixed beam laser welding processes can be limited by strict gap tolerance, thermal distortion, heat affected zone, etc. Thus, a system and/or method that improves on conventional laser based welding systems is desirable.

### SUMMARY

This disclosure relates generally to laser welding systems, methods, and apparatuses. More particularly, this disclosure relates to laser welding systems for aluminum alloys and methods of laser welding aluminum alloys are disclosed, substantially as illustrated by and described in connection with at least one of the figures, as set forth more completely in the claims.

### BRIEF DESCRIPTION OF THE DRAWINGS

FIG. 1 is a schematic diagram of an example laser welding system in accordance with aspects of this disclosure.

FIG. 2 illustrates an example pattern that may be used by a laser scanner to move the focal point of a laser beam in multiple dimensions over the workpiece, in accordance with aspects of this disclosure.

FIGS. 3A and 3B illustrate an example superimposed pattern traced over a workpiece with the focal point of the lasing power of FIG. 1, in accordance with aspects of this disclosure.

FIG. 4A illustrates a beam path of a fixed laser beam and a cross-sectional view of a workpiece, and FIG. 4B illustrates an example beam path of an oscillating laser beam and a cross-sectional view of a workpiece, in accordance with aspects of this disclosure.

FIG. 5A illustrates a weld puddle created by a fixed laser beam, and FIG. 5B illustrates an example weld puddle created by an oscillating laser beam, in accordance with aspects of this disclosure.

FIG. 6 illustrates a representation of a weld puddle, in accordance with aspects of this disclosure.

FIGS. 7A-7E illustrate example data generated by an oscillating laser beam, in accordance with aspects of this disclosure.

FIG. 8 illustrates the example data generated by a fixed laser beam, in accordance with aspects of this disclosure.

FIG. 9A illustrates example heating and cooling profiles associated with a fixed laser beam, and FIG. 9B illustrates example heating and cooling profiles associated with an oscillating laser beam, in accordance with aspects of this disclosure.

FIG. 10A illustrates example heating and cooling profiles associated with a fixed laser beam, and FIG. 10B illustrates example heating and cooling profiles associated with an oscillating laser beam, in accordance with aspects of this disclosure.

FIG. 11A illustrates an example temperature map of a molten pool generated by a fixed laser beam, and FIG. 11B illustrates an example temperature map of a molten pool generated by an oscillating laser beam, in accordance with aspects of this disclosure.

FIG. 12A illustrates the example circular pattern of FIG. 2, and FIG. 12A illustrates example control waveforms for controlling the lasing power and the focal point, in accordance with aspects of this disclosure.

FIG. 13A illustrates a cross-sectional image of a solidified weld bead created by a fixed laser beam, and FIG. 13B illustrates a cross-sectional image of a solidified weld bead created by an oscillating laser beam, in accordance with aspects of this disclosure.

FIG. 14A is an image depicting a cross section of a welded aluminum workpiece using conventional aluminum welding techniques and FIG. 14B is an enhanced image showing resulting hot cracking in the weld.

FIG. 15A is an image depicting a cross section of another welded aluminum workpiece welded using disclosed example welding methods and apparatus, and FIG. 15B is an enhanced image showing no cracking present in the finished weld.

FIG. 16 is a flowchart representative of an example process to perform welding, cladding, and/or additive manufacturing operations using lasing power, in accordance with aspects of this disclosure.

### DETAILED DESCRIPTION

Hot cracking is the formation of shrinkage cracks during the solidification of weld metal, and is the primary form of weld defect when welding aluminum alloys. Conventionally, when welding 6000-series aluminum alloys (i.e., aluminum alloyed with magnesium and silicon), hot cracking is mitigated by adding filler material to the weld to increase the magnesium content and/or the silicon content. For example, regarding welding of 6000 series aluminum, the website “Aluminum Welding Frequency Asked Questions” published by The Lincoln Electric Company (http://www.lincolnelectric.com/en-us/support/welding-solutions/Pages/aluminum-faqs-detail.aspx) urges welders, “Never try to weld these alloys without using filler metal.” However, conventional techniques involving adding filler metal increase the complexity and cost of welding aluminum, and slow down the welding speed.

Disclosed examples are capable of welding aluminum alloys, including 6000 series aluminum alloys (e.g., containing magnesium and silicon) without using filler metal and without causing hot cracking in the finished weld. In some disclosed examples, a laser welding system for welding aluminum includes a laser generator to generate welding-type lasing power, a lens to focus the welding-type lasing power at a focal point on an aluminum workpiece to generate a weld puddle, and a laser scanner to control the lens to move the focal point of the welding-type lasing power in multiple dimensions over the aluminum workpiece during welding, were the laser generator and the laser scanner perform the welding without filler metal being added to the workpiece during the welding.

Thus, the total heat input is greatly reduced so that the thermal distortion and residual stress will be reduced. The puddle is controlled at a relatively small size so that the collapse and drooping issues can be greatly mitigated.

For the purpose of promoting an understanding of the principles of the claimed technology and presenting its currently understood best mode of operation, reference will be now made to the examples illustrated in the drawings, and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

As used herein, the word “exemplary” means serving as an example, instance, or illustration. The examples described herein are not limiting, but rather are exemplary only. It should be understood that the described examples are not necessarily to be construed as preferred or advantageous over other examples. Moreover, the term “examples” does not require that all examples of the disclosure include the discussed feature, advantage, or mode of operation.

As used herein, the term “welding-type operation” includes to a welding operation and/or a cladding operation and/or additive manufacturing.

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

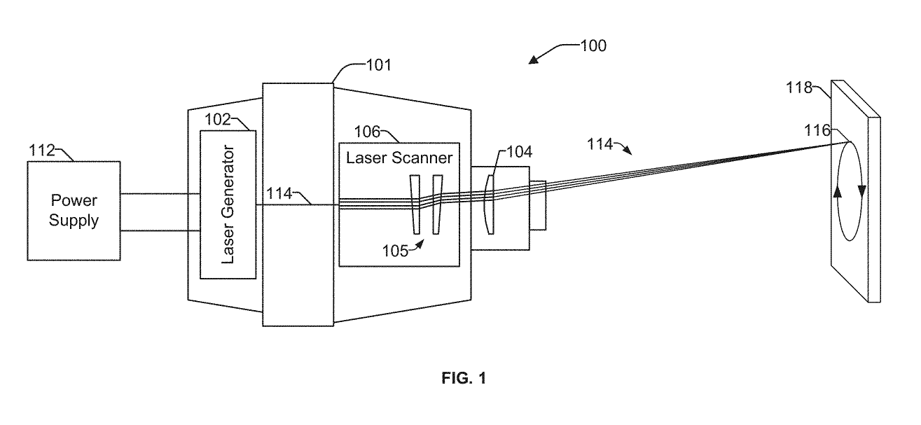

FIG. 1 is a schematic diagram of an example laser welding system 100. The example laser welding system 100 of FIG. 1 is capable of improved welding of aluminum alloys such as, but not limited to, 6000 series aluminum alloys. The example system 100 of FIG. 1 has the advantage that introduction of filler metal is neither necessary nor desirable to perform welding while also avoiding hot cracking in finished welds. The example system 100 also has larger gap tolerance in butt joints and lap joints. The example laser welding system 100 of FIG. 1 includes a laser processing head 101, a laser generator 102, a lens 104, one or more optics 105 integrated with a laser scanner 106, and a power supply 112.

The laser generator 102 generates welding-type lasing power 114 (e.g., directed light energy) based on input power received from the power supply 112. The laser generator 102 may be a light emitting diode-type laser or any other type of laser generator. As used herein, welding-type lasing power refers to lasing power having wavelength(s) that are suitable for delivering energy to metal for welding or cladding.

The lens 104 focuses the welding-type lasing power 114 at a focal point 116 on a workpiece 118. The welding-type lasing power 114 heats the workpiece 118 to generate a puddle during welding and/or cladding operations.

During a welding process, the laser scanner 106 controls the laser beam to move the focal point 116 of the welding-type lasing power 114 in multiple dimensions over the workpiece 118 (e.g., by lens 104) during welding or cladding. The example laser scanner 106 may be any type of remote laser scanning head using reflective optics. The laser scanner 106 of FIG. 1 can be a rotary wedge scanner, such as the Rotary Wedge Scanner sold by Laser Mechanisms, Inc. By moving the focal point 116 in multiple directions, the laser scanner 106 can control the heating and/or cooling rates in the weld puddle.

The laser generator 102 and the laser scanner 106 cooperate to control the lasing power level, the location of the focal point 116, and/or the speed of travel of the focal point 116 to prevent hot cracking and porosity in the welded aluminum. For example, the laser generator 102 and the laser scanner 106 are configured to control the lasing power level and the travel speed applied to the workpiece 118 to prevent silicide precipitation and concentration along the grain boundary in the weld puddle from increasing to higher than a threshold concentration that corresponds to hot cracking. By controlling the heating and cooling rates in the weld puddle, the silicide in 6000 series aluminum can be frozen in place before the silicide can migrate to the grain boundary enough to cause hot cracking in the finished weld. In some examples, the laser generator and/or the laser scanner 106 use one or more control waveforms that result in changes in the lasing power level, the location of the focal point 116, and/or the speed of travel of the focal point 116 based on the location (e.g., the instantaneous location) of the focal point 116.

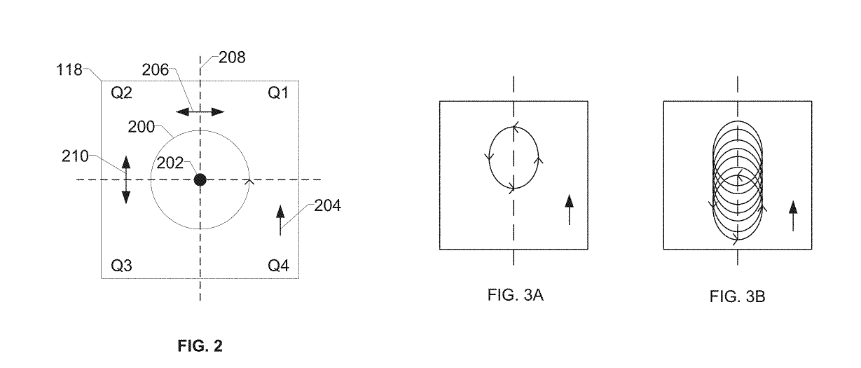

The laser scanner 106 is configured to move the focal point 116 in a pattern with respect to a reference point 202 of the lens 104. FIG. 2 illustrates an example pattern 200 that may be used by the laser scanner 106 to move the focal point 116 in multiple dimensions over the workpiece 118. The pattern 200 illustrated in FIG. 2 is a circular pattern, but other patterns may also be used. It should be noted, however, any desired pattern may be utilized, and the laser scanner 106 may be adapted to implement these patterns, among others. The desired pattern may include, but is not limited to, a pattern with one or more straight lines and/or one or more curves. In some embodiments, the desired pattern may include a pause or break in the pattern, such as a time interval in which the laser scanner 106 does not move the focal point 116. The desired pattern may include a circle, an ellipse, a zigzag, a figure-8, a transverse reciprocating line, a crescent, a triangle, a square, a rectangle, a non-linear pattern, an asymmetrical pattern, a pause, or any combination thereof. As may be appreciated, a pattern or a combination of patterns may be used and optimized for particular welds and/or welding positions. The movement of the focal point 116 and the relative movement between the workpiece 118 and the laser scanner 106 (e.g., by moving the workpiece 118 against a direction of welding 204) cause the focal point 116 to trace a superimposed pattern over the workpiece 118.

As illustrated in FIG. 2, the pattern 200 includes movement in a lateral direction 206 (e.g., a direction transverse or perpendicular to a weld or cladding path 208) and movement in a longitudinal direction 210 (e.g., a direction parallel with the weld or cladding path 208). The focal point 116 may be directed in a clockwise direction and/or in a counterclockwise direction along the pattern. To generate the example circular pattern 200 shown in FIG. 2, the laser scanner 106 oscillates the focal point 116 in the lateral direction 206 and in the longitudinal direction 210. Although illustrated as circular in FIG. 2, the movement can be generated in any pattern desired to create the desired effect (e.g., heating profile, weld rate, etc.).

In some examples, the system 100 includes one or more air knives keep the laser scanner 106 (e.g., the optics of laser scanner 106) clean, and/or remove smoke and/or spatter from the area proximate the puddle.

FIGS. 3A and 3B illustrate an example superimposed pattern 300 traced over a workpiece with the focal point 116 of the lasing power 114 of FIG. 1. As illustrated in FIG. 3A, the combination of a circular pattern used by the laser scanner 106 to move the focal point 116 and the movement of the workpiece 118 causes an elongated pattern to be traced over the workpiece. As the laser scanner 106 moves the focal point 116, the lasing power 114 creates a heat gradient in the weld puddle. The changing heat gradient changes the surface tension of the puddle, inducing a stirring effect, thereby improving the resulting weld. In some examples, agitation or stirring of the weld puddle prevents concentration and/or migration of silicides to the grain boundary, thereby preventing or reducing the likelihood of hot cracking.

In some examples, the laser generator 102 adjusts the power level of the lasing power 114 and/or the laser scanner 106 adjusts a rotation speed of the laser scanner 106 and/or a size of a focal area in which the focal point 116 is limited (e.g., the radius of the pattern 200) based on a location of the focal point 116 with respect to a reference point. For example, the lasing power level, the rotation speed of the laser scanner 106, and/or the focal area size may be modified to achieve a desired puddle effect and/or to affect the heating and/or cooling rates of the puddle.

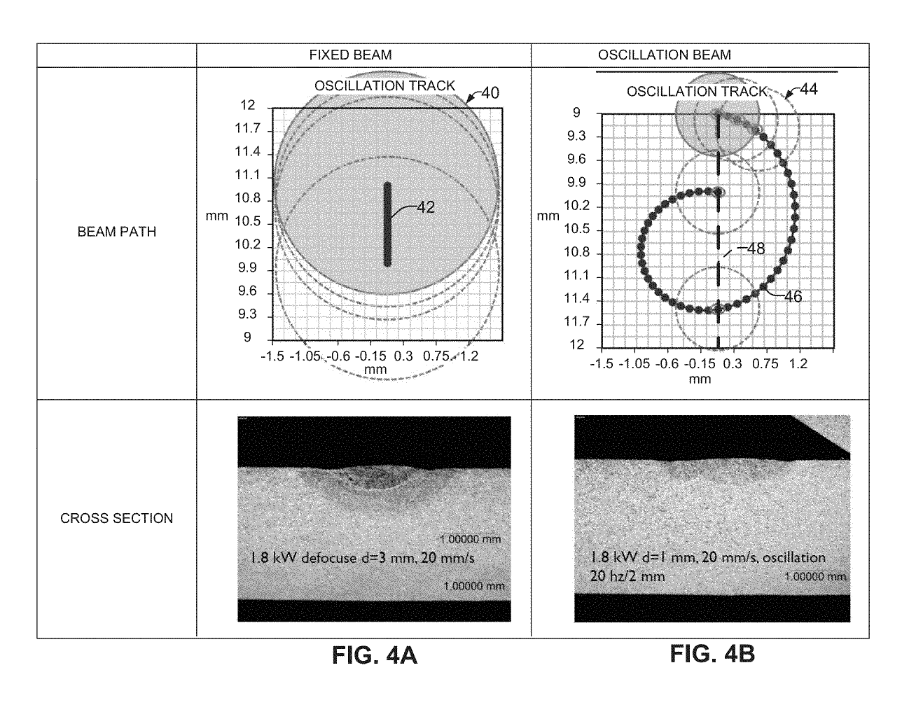

As shown in FIG. 4A, a weld generated by a fixed laser beam 40 traverses a joint between two workpieces along a beam path such that the center of the laser beam 42 aligns with the centerline at the joint. In other words, the path of the laser beam 40 directly follows the joint between the two workpieces.

By contrast, an oscillating or moving laser beam 44 performs a weld by advancing over the joint not in a fixed beam pathway, but by moving the beam path about the centerline 48 as the beam 44 advances, as illustrated in FIG. 4B. In an example, a laser beam 44 can be rotated about a centerline in a substantially circular manner. The laser beam 44 is rotated in a circular fashion such that a portion of the beam 44 overlaps the joint between two workpieces as the laser beam 44 advances along the joint.

In some examples, the oscillating beam 44 has a smaller diameter than a fixed beam 40. As the beam 44 is rotated about the joint, the edge of the oscillating beam 44 may stay within a distance from the centerline 48 that is similar to the wider, fixed laser beam 40.

In examples, the oscillating beam 44 has a power level and rate of travel substantially equivalent to a fixed laser beam 40 that is used to perform a similar weld. In other examples, the power level and rate of travel can be changed to achieve a desired result.

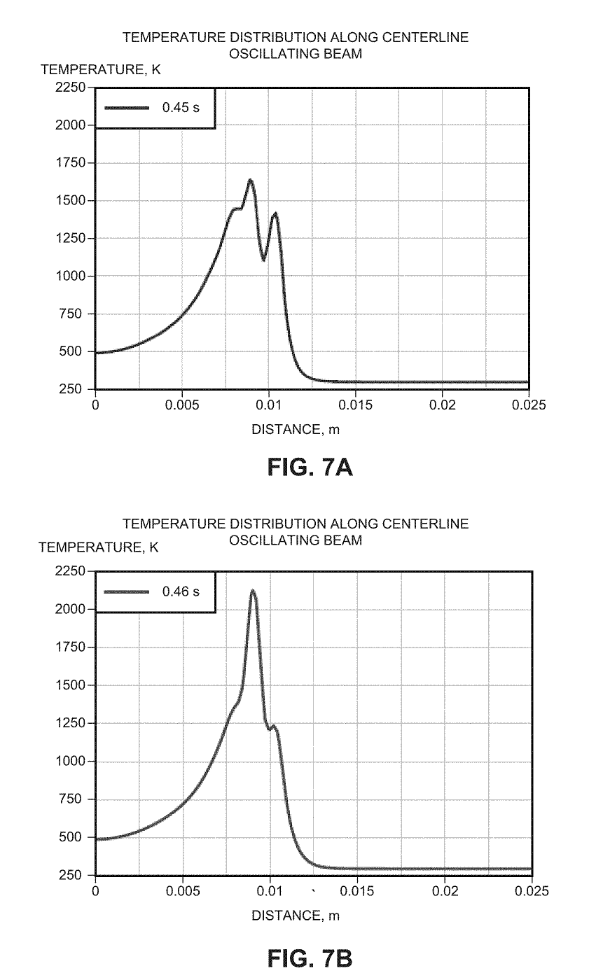

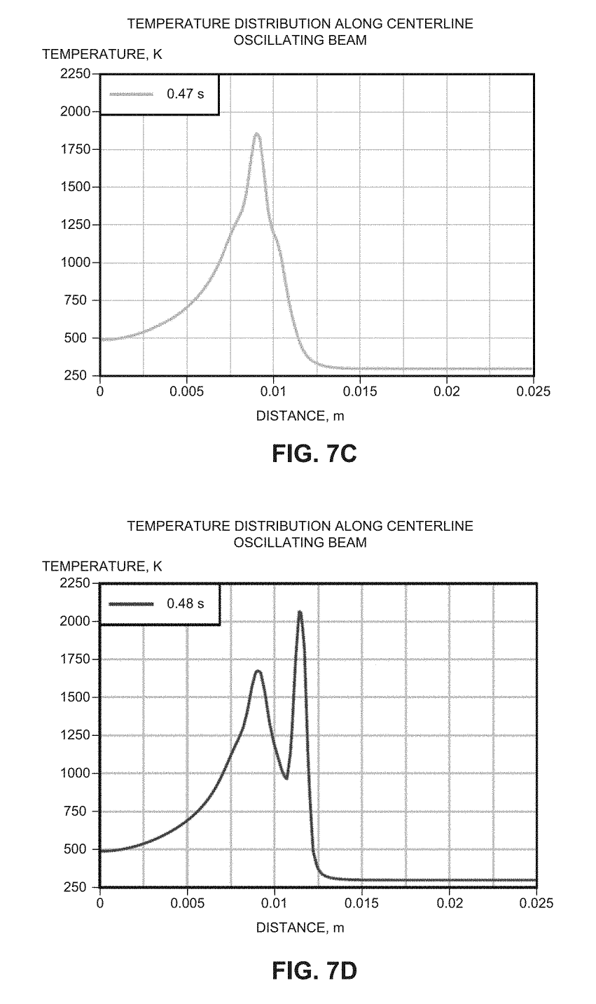

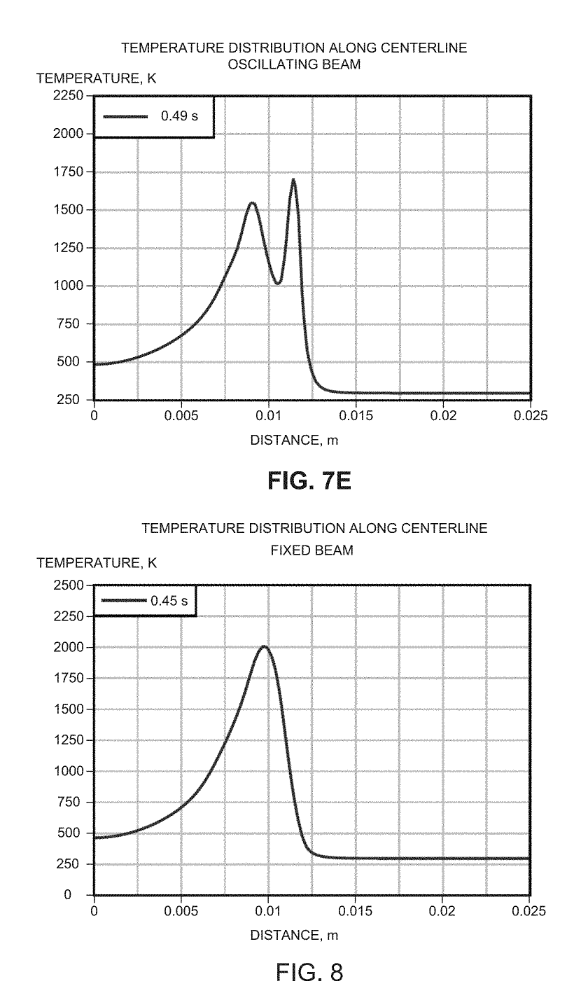

Advantageously, the movement of the oscillating laser beam 44 dissipates the heat over a wider area. The heat affected zone is smaller and the heat distribution across the weld is more uniform. As shown in FIG. 4B, the center of the oscillating laser beam 44 crosses the centerline 48 (e.g., the joint) as it rotates and advances. As shown in the graphical data represented in FIGS. 7A to 7E, these points correspond to temporary peaks in temperature, whereas a fixed beam will keep the intense temperature at the joint continuously, as shown in FIG. 8.

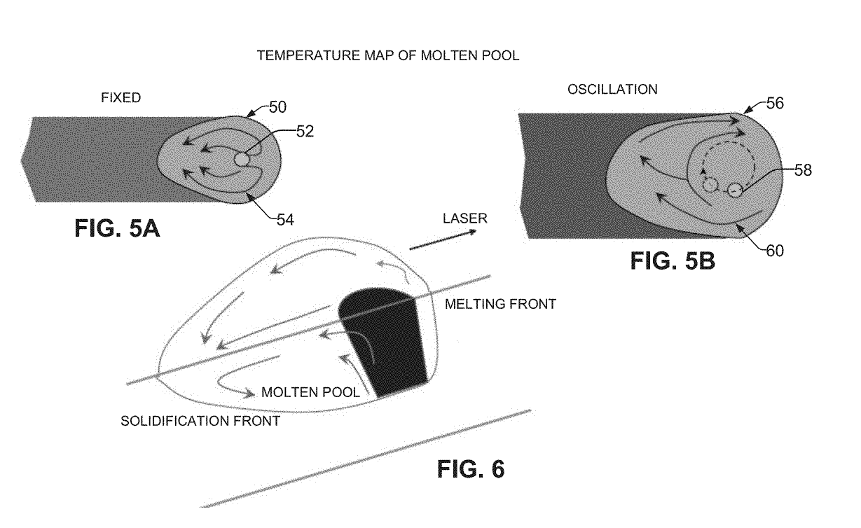

As shown in the example of FIGS. 5B and 6, as the oscillating laser beam 58 advances, the molten metal 56 is “stirred” in a generally clockwise manner 60. The circular movement of the oscillating laser beam 58 creates a current 60 within the puddle 56. For instance, the molten metal flows in a rotational pattern influenced by the beam's movement. By contrast, as shown in FIG. 5A, molten metal 50 in the wake of a fixed beam 52 flows rearward from both sides of the beam, illustrated by the currents 54.

FIGS. 7A to 7E illustrate graphical data representing the temperature distribution along a centerline during a welding operation using an oscillating laser beam, as described with respect to FIGS. 1-6. For instance, FIG. 7A begins a 0.45 seconds into the weld operation, showing a peak between 1500 and 1750 degrees Kelvin at approximately 0.009 meters from the centerline. At 0.46 seconds, the temperature spikes above 2000 degrees Kelvin. As shown in FIGS. 7D and 7E, the temperature spikes are separated, representing the distribution of the heating profile as the laser traverses the centerline (e.g., the weld joint). By contrast, as shown in FIG. 8, a fixed beam laser will maintain a focused peak of temperature, as the weld path does not deviate from the joint.

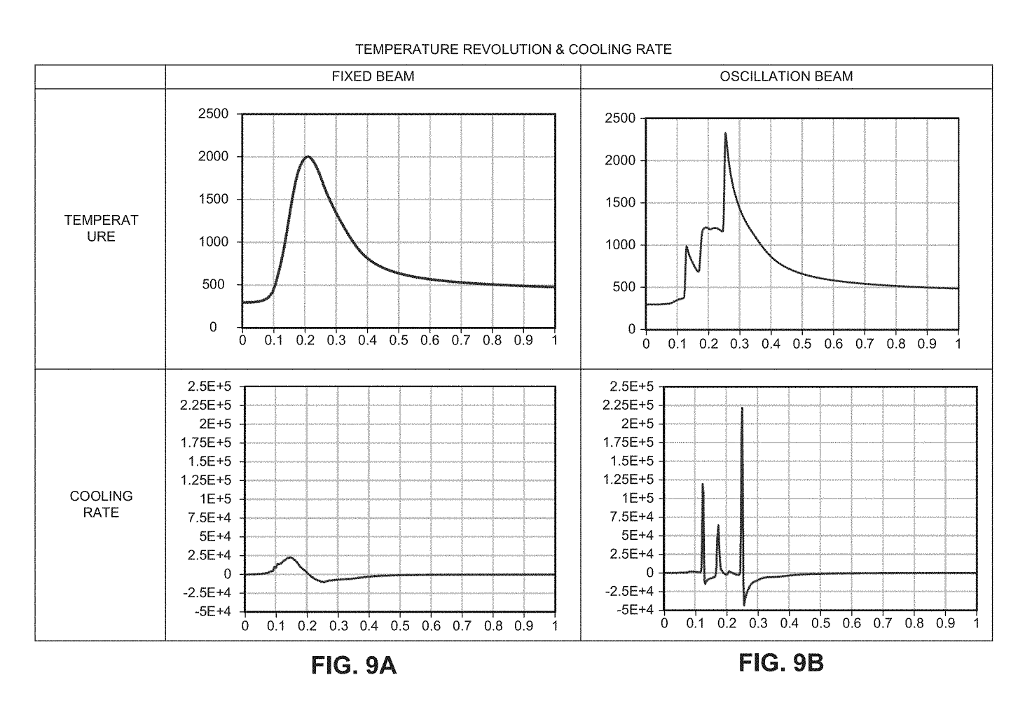

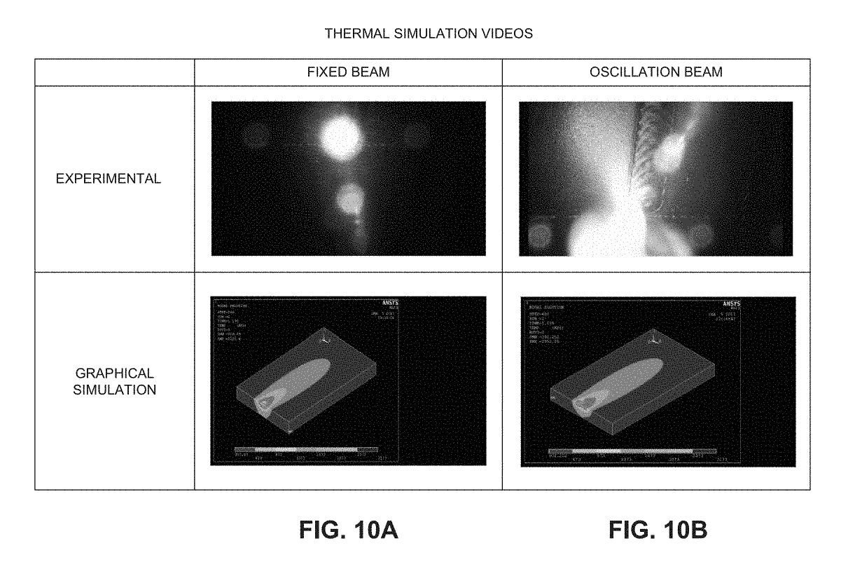

Several advantages stem from the movement of the oscillating beam. For example, compared to a heating profile and cooling rate of a fixed beam laser, shown in FIG. 9A, the heating profile is more distributed, and the cooling rate is increased in the weld puddle created by the oscillating beam, as shown in FIG. 9B. FIGS. 10A and 10B illustrate thermal simulations, represented as a video of an actual weld and a graphical representation thereof. FIGS. 10A and 10B represent a fixed beam laser weld and an oscillating beam laser weld, respectively.

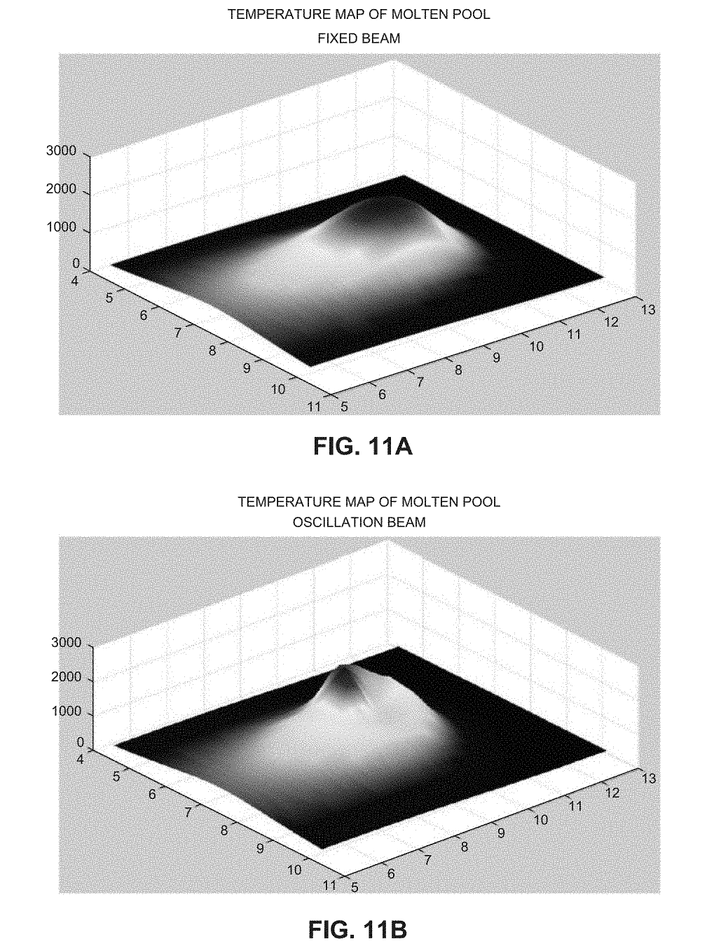

The advantageous heating profile of the oscillating weld is further illustrated in a temperature map of a molten pool, shown in FIG. 11B. As shown, the temperature peak is sharper, representing a faster cooling rate, compared with a temperature map of a molten pool generated by a fixed beam laser, shown in FIG. 11A.

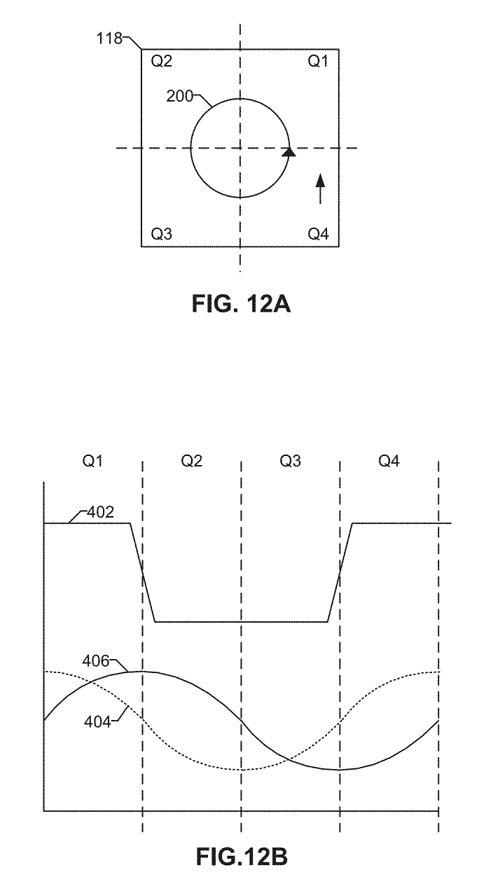

FIG. 12A illustrates the example circular pattern 200 of FIG. 2. FIG. 12B illustrates control waveforms 402, 404, 406 for controlling the lasing power 114 and the focal point 116. In the example of FIG. 12B, the waveform 402 represents the lasing power generated by the laser generator 102 and applied to the focal point. The waveform 404 represents a lateral position command provided to the laser scanner 106 to control a lateral position of the focal point 116 and the waveform 404 represents a lateral position command provided to the laser scanner 106 to control a longitudinal position of the focal point 116.

In the example of FIG. 12A, the laser generator 102 and the laser scanner 106 apply more welding-type lasing power to a first lateral portion of the workpiece 118 (e.g., than to a second lateral portion of the workpiece 118, the first and second portions of the workpiece being separated laterally and being at least partially coextensive longitudinally, more lasing power is applied to quadrants Q1 and Q4 (defined with respect to a reference, such as a center point of the boundaries focal point area) than to quadrants Q2 and Q3. As a result, different power is applied to different lateral sections of the weld path. However, other lasing power distributions may be applied using other lasing power control waveforms. For example, more lasing power may be applied to a leading edge than to a trailing edge (e.g., power being applied differently longitudinally) and/or vice versa, and/or more or less lasing power may be applied to a particular quadrant. The waveform 402 may be modified to implement any desired lasing power application.

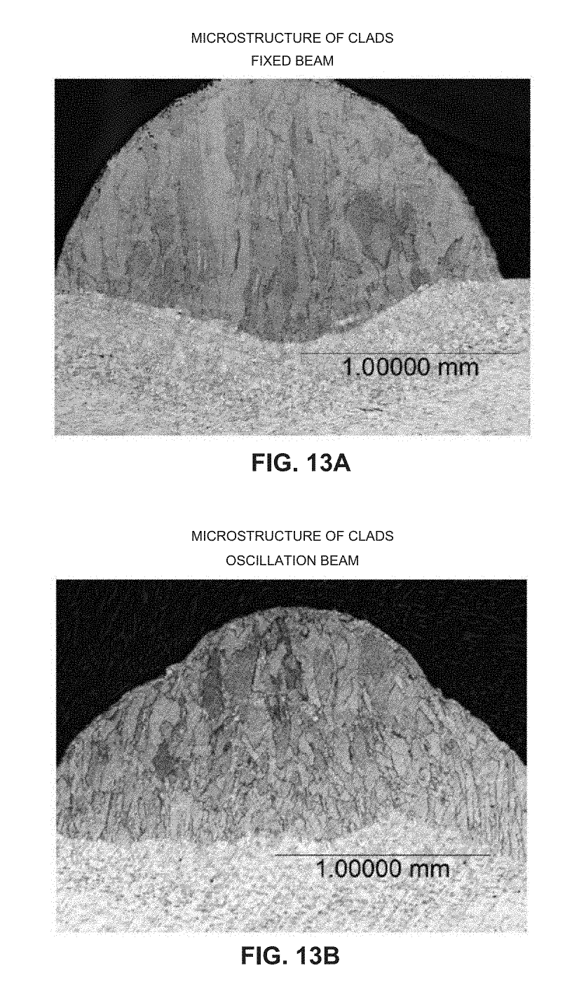

FIGS. 13A and 13B show a comparison of cross sections of solidified weld beams created by both a fixed laser beam and an oscillating laser beam, respectively.

As shown in FIG. 13A, the weld created with a fixed beam has a deeper penetration at the center. Large grains with columnar structure were generated, perpendicularly to the welding interface.

By contrast, and as shown in FIG. 13B, as a result of the oscillating laser beam, the weld has a shallower penetration and more uniform welding interface. The microstructure is finer with variant growth directions.

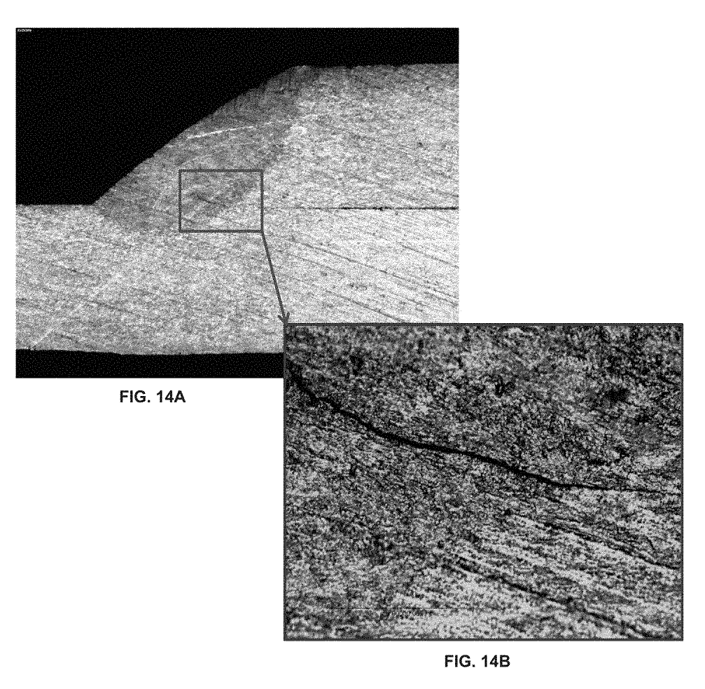

FIG. 14A is an image 600 depicting a cross section of a welded aluminum workpiece using conventional aluminum welding techniques. FIG. 14B is an enhanced image showing resulting hot cracking in the weld.

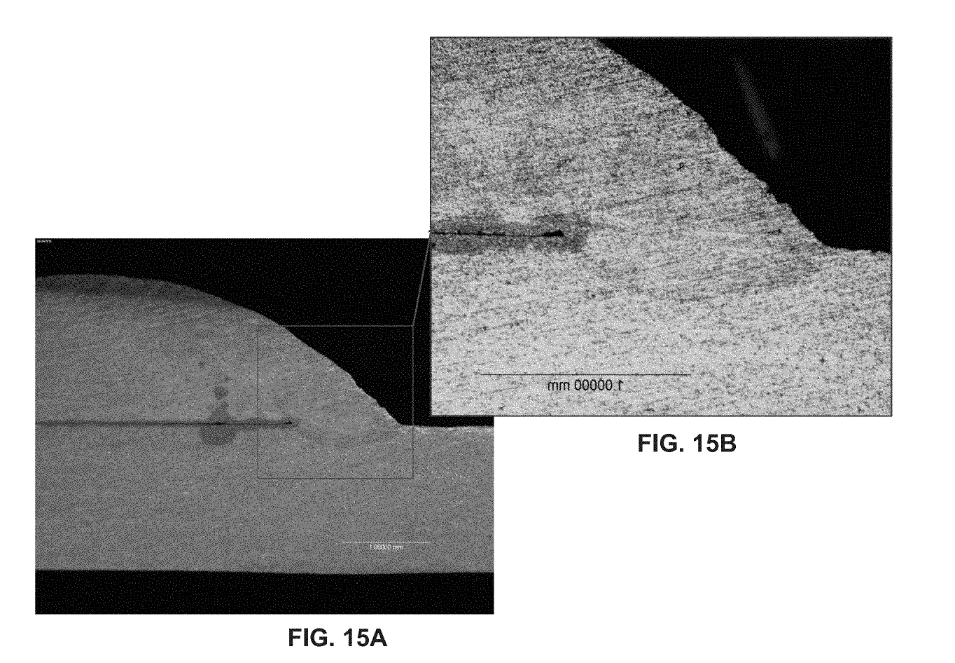

FIG. 15A is an image depicting a cross section of another welded aluminum workpiece welded using disclosed example welding methods and apparatus, and FIG. 15B is an enhanced image showing no cracking present in the finished weld. The example depicted in FIGS. 15A and 15B are of laser welding aluminum without filler metal and avoiding hot cracking of the weld was welding a lap joint using a fiber laser, for example, a laser sold by IPG Photonics Corporation of Oxford, Mass. The example weld performed in FIGS. 15A and 15B without hot cracking involved using a laser wavelength of 1064 nanometers (nm) on a lap joint of 6061 Aluminum alloy having a thickness of 1.5 millimeters (mm). The weld involved a laser spot size of 1.2 mm, 3.8 kilowatts (kW) of laser power, a travel speed of 20 mm/s, an oscillation diameter of 3 mm, and an oscillation frequency of 25 rotations per second (rps).

Example welds may be accomplished with an oscillation diameter range between 1 mm and 4 mm, an oscillation frequency of the rotary wedge scanner between 25 rps and 90 rps. Example aluminum thicknesses for a lap joint weld range from 0.75 mm to 7 mm. An increase in oscillation frequency enables a faster travel speed and/or more laser power. For example, increasing the rotation speed to 60 rotations per second will allow an approximate increase of travel speed to 35 mm/s and an increase of laser power to 5.7 kW, while maintaining a similar heat input per area and per unit of time.

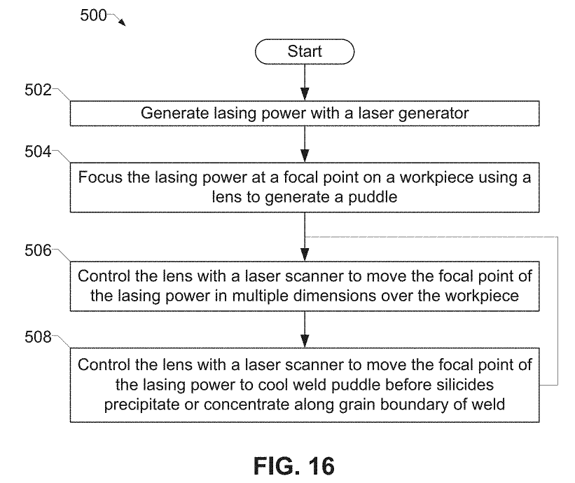

FIG. 16 is a flowchart representative of an example process 500 to perform welding or cladding operations using lasing power. The example process 500 may be performed using the system 100 of FIG. 1 or another laser welding system. Block 502 involves generating lasing power with a laser generator, such as the laser generator 102 of FIG. 1. In some cases, the laser generator 102 uses a waveform to determine the lasing power at a given time. The laser generator 102 outputs the lasing power 114 to the laser scanner 106 and the lens 104. Block 504 involves focusing the lasing power 114 at a focal point 116 on a workpiece 118 using the lens 104 to generate a puddle.

Block 506 involves controlling the lens 104 with the laser scanner 106 to move the focal point 116 in multiple dimensions over the workpiece 118. For example, the laser scanner 106 may direct the focal point 116 to form one or more patterns such as the pattern 200 of FIG. 2. Block 508 involves controlling the lens 104 with the laser scanner 106 to move the focal point 116 of the lasing power 114 to cool the weld puddle before silicides (e.g., magnesium silicide) precipitate or concentrate along the grain boundary of the weld. Blocks 506 and 508 may be performed by providing positional data to a rotary wedge scanner, which directs the lasing power 114 and/or the lens 104 to move the focal point 116.

Blocks 506 and 508 may iterate to perform a welding or cladding operation by continually heating and cooling the weld puddle using the lasing power 114 while controlling the laser scanner 106 to move the focal point 116 over the workpiece 118 in multiple dimensions.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A laser welding device to weld aluminum, comprising:
a laser generator to generate welding-type lasing power;
a lens to focus the welding-type lasing power at a focal point on an aluminum workpiece to generate a weld puddle; and
a laser scanner to control the lens to move the focal point of the welding-type lasing power in multiple dimensions over the aluminum workpiece during welding, the laser generator and the laser scanner to perform the welding without filler metal being added to the workpiece.

2. The laser welding device as defined in claim 1, wherein the laser scanner is configured to move the focal point in a circle, an ellipse, a zigzag, a figure-8, a transverse reciprocating line, a crescent, a triangle, a square, a rectangle, a non-linear pattern, an asymmetrical pattern, a pause, or any combination thereof.

3. The laser welding device as defined in claim 2, wherein the movement of the focal point and relative movement between the aluminum workpiece and the laser scanner cause the focal point to trace an oblong pattern over the aluminum workpiece.

4. The laser welding device as defined in claim 1, wherein the laser scanner is configured to move the focal point such that energy distribution across the weld is changed, thereby a controllable thermal gradient is created in the puddle by the welding-type laser power.

5. The laser welding device as defined in claim 4, wherein the laser generator and the laser scanner are configured to control the welding-type lasing power and the travel speed applied to the workpiece to prevent threshold amounts of silicide precipitation and to prevent concentration along the grain boundary in the weld puddle from exceeding a threshold concentration that corresponds to hot cracking.

6. The laser welding device as defined in claim 4, wherein the laser scanner is configured to move the focal point to cause lateral movement of the weld puddle with respect to a weld path.

7. The laser welding device as defined in claim 1, wherein the laser generator or the laser scanner are to adjust, based on a location of the focal point with respect to a reference point, at least one of a lasing power level, a rotation speed of the laser scanner, or a size of a focal area in which the focal point is limited.

8. The laser welding device as defined in claim 1, wherein the laser scanner is to control the focal point based on the aluminum workpiece being an aluminum alloy including magnesium and silicon.

9. The laser welding device as defined in claim 1, wherein the laser scanner is configured to move the focal point laterally across a weld path and longitudinally in a direction parallel to the weld path.

10. The laser welding device as defined in claim 1, wherein the laser scanner comprises a rotary wedge scanner.

11. The laser welding device as defined in claim 1, wherein the lens is to focus the lasing power at the focal point on a lap joint or a butt joint comprising aluminum or an aluminum alloy.

12. The laser welding device as defined in claim 1, wherein the aluminum workpiece comprises a lap joint of an aluminum alloy, the lens being configured to focus the lasing power on a consistent laser spot size, the laser scanner being configured to move the focal point in a circular path having a predetermined oscillation diameter.

13. A method to weld aluminum, comprising:
generating welding-type lasing power;
focusing the welding-type lasing power at a focal point on an aluminum workpiece using a lens to generate a weld puddle; and
controlling the lens with a laser scanner to move the focal point of the welding-type lasing power in multiple dimensions over the aluminum workpiece to perform the welding without filler metal being added to the workpiece during welding.

14. The method as defined in claim 13, wherein the controlling of the lens comprises moving the focal point in a circle, an ellipse, a zigzag, a figure-8, a transverse reciprocating line, a crescent, a triangle, a square, a rectangle, a non-linear pattern, an asymmetrical pattern, a pause, or any combination thereof.

15. The method as defined in claim 14, wherein the controlling of the lens with the laser scanner comprises controlling the focal point and relative movement between the workpiece and the laser scanner to trace an oblong pattern over the aluminum workpiece with the welding-type lasing power.

16. The method as defined in claim 13, wherein the laser scanner comprises a rotary wedge scanner.

17. The method as defined in claim 13, wherein the controlling of the lens comprises moving the focal point such that a heat gradient is created in the weld puddle by the welding-type lasing power.

18. The method as defined in claim 17, wherein the controlling of the lens comprises controlling the welding-type lasing power applied to the workpiece to prevent silicide concentration in the weld puddle from exceeding a threshold concentration that corresponds to hot cracking.

19. The method as defined in claim 13, wherein welding of the aluminum workpiece does not include adding a filler material.

20. The method as defined in claim 13, further comprising adjusting, based on a location of the focal point with respect to a reference point, at least one of a lasing power level, a rotation speed of the laser scanner, or a size of a focal area in which the focal point is limited.
